(19) United States
(12) Patent Application Publication
(10) Pub. No.: US 2013/0312033 A1
(43) Pub. Date: Nov. 21, 2013

(54) METHOD FOR SCHEDULING A BROADCAST BASED ON VIEWING TIME AND BROADCAST RECEIVING APPARATUS

(71) Applicant: SAMSUNG ELECTRONICS CO., LTD., Gyeonggi-do (KR)

(72) Inventors: Hyen-ji LEE, Suwon-si (KR); Joon-hwan KIM, Yongin-si (KR); Chang-soo LEE, Seoul (KR)

(73) Assignee: SAMSUNG ELECTRONICS CO., LTD., Gyeonggi-do (KR)

(21) Appl. No.: 13/950,064

(22) Filed: Jul. 24, 2013

Related U.S. Application Data
(63) Continuation-in-part of application No. 12/015,753, filed on Jan. 17, 2008.

(30) Foreign Application Priority Data
Jul. 19, 2007 (KR) 10-2007-0072139

(51) Int. Cl. H04N 21/458

(52) U.S. Cl. CPC H04N 21/458
USPC 725/39; 725/134; 725/97

(57) ABSTRACT

A method for scheduling a broadcast is provided. The method includes receiving and outputting a broadcast program, when an event which stops an output of the broadcast program occurs while the broadcast program has not been completed, receiving a user command to watch the broadcast program continuously later, when the user command is received, storing information regarding the broadcast program, and outputting portions of the broadcast program which have not been output continuously using the stored broadcast program information.

### CROSS-REFERENCE TO RELATED APPLICATIONS

This application is a Continuation-In-Part of U.S. Application No. 12/015,753, filed on Jan. 17, 2008, which claims priority from Korean Patent Application No. 10-2007-0072139, filed on Jul. 19, 2007, in the Korean Intellectual Property Office, the disclosures of which are hereby incorporated herein by reference in their entireties.

### BACKGROUND OF THE INVENTION

1. Field of the Invention

Apparatuses and methods consistent with the present invention relate to providing a method for scheduling a broadcast and a broadcast receiving apparatus using the same, and more particularly, to providing a method for scheduling a broadcast based on a viewing time and a broadcast receiving apparatus using the same.

2. Description of the Related Art

FIG. 1 illustrates an Electronic Program Guide (EPG) which is executed to schedule a broadcast in the conventional art.

The EPG 10 includes a broadcast screen section 11 to show a current program, a section 12 to select a channel, and a section 13 to show broadcast information.

In order to schedule viewing or recording of a broadcast, a user may execute the EPG 10. If the EPG 10 is executed, the user adjusts the channel selection section 12 to browse a channel of the desired program. If the channel is selected, the user searches for the time zone of the desired program, identifies the broadcast information, and schedules the desired program.

The user has to execute the EPG in order to record or view broadcasts relating to the currently viewed broadcast as well as currently unviewed broadcasts.

In addition, in the case of the currently viewed program, if the user does not execute the EPG, the user has to request to schedule a rebroadcast or a subsequent broadcast of the current broadcast while viewing the current broadcast, resulting in user inconvenience.

Therefore, there is a need for a method for scheduling a broadcast based on the viewing time and a broadcast receiving apparatus using the same.

### SUMMARY OF THE INVENTION

Exemplary embodiments of the present invention address at least the above problems and/or disadvantages and other disadvantages not described above. Also, the present invention is not required to overcome the disadvantages described above, and an exemplary embodiment of the present invention may not overcome any of the problems described above.

The present invention provides a method for scheduling a broadcast to easily schedule broadcasts relating to the current broadcast based on a viewing start time by detecting the viewing start time of the current broadcast.

A method for scheduling a broadcast according to an exemplary embodiment includes receiving and outputting a broadcast program, when an event which stops an output of the broadcast program occurs while the broadcast program has not been completed, receiving a user command to watch the broadcast program continuously later, when the user command is received, storing information regarding the broadcast program, and outputting portions of the broadcast program which have not been output continuously using the stored broadcast program information.

The event may be at least one of changing channels, turning off a broadcast receiving apparatus, and impossibility of receiving broadcast of the broadcast receiving apparatus.

The receiving the user command may include outputting a message asking whether to watch the broadcast program continuously later and receiving a response to the message through user interface.

The stored broadcast program information may be at least one of an entire running time, viewing time, title, identification information, channel information and storage capacity.

The method may further include, when the user command is received, receiving a content corresponding to portions of the broadcast program which have not been broadcast from a VOD server and storing the content, and the outputting portions of the broadcast program which have not been output continuously may include reading out and outputting the content received and stored from the VOD server.

When the event which stops an output of the broadcast program is completed, portions of the broadcast program which have not been broadcast may be output continuously.

The outputting portions of the broadcast program which have not been output continuously may include, when a predetermined time elapses after the event which stops an output of the broadcast program is completed, outputting a message asking whether to output portions of the broadcast program which have not been broadcast continuously, and when a response to the output message is received through user interface, outputting portions of the broadcast program which have not been broadcast continuously.

The outputting portions of the broadcast program which have not been output continuously may include, when the event which stops an output of the broadcast program is completed and a predetermined user input is received, outputting a message asking whether to output portions of the broadcast program of the broadcast program which have not been broadcast continuously, and when a response to the output message is received through user interface, outputting portions of the broadcast program which have not been broadcast continuously.

The outputting portions of the broadcast program which have not been output continuously may include, when the event which stops an output of the broadcast program is completed and a command to turn on a broadcast receiving apparatus is received, outputting a message asking whether to output portions of the broadcast program which have not been broadcast continuously, and when a response to the output message is received through user interface, outputting portions of the broadcast program which have not been broadcast continuously.

The outputting portions of the broadcast program which have not been output continuously may include, if there are a plurality of broadcast programs which have not been broadcast completely, when the event which stops an output of the broadcast program is completed, outputting information regarding a list of the broadcast programs which have not been broadcast completely, and when one item is selected from a list of the broadcast programs which have not been broadcast completely through user interface, outputting a broadcast program corresponding to the selected item continuously.

A broadcast receiving apparatus according to an exemplary embodiment includes a broadcast signal receiving unit which receives a broadcast program, a broadcast output unit which outputs the received broadcast program, a user command receiving unit which receives a user command to watch the broadcast program later continuously when the event which stops an output of the broadcast program occurs while the broadcast program has not been completed, a storage unit which stores the received broadcast program when the user command is received, and a control unit which controls to output portions of the broadcast program which have not been broadcast continuously using the store information regarding the broadcast program.

The event may be at least one of changing channels, turning off a broadcast receiving apparatus, and impossibility of receiving broadcast of the broadcast receiving apparatus.

The control unit may control to output a message asking whether to watch the broadcast program continuously later, and receive a response to the message through the user command receiving unit.

The stored broadcast program information may be at least one of an entire running time, viewing time, title, identification information, channel information and storage capacity.

The control unit, when the user command is received, may control to receive a content corresponding to portions of the broadcast program which have not been broadcast from a VOD server, store the content, read out and output the content received and stored from the VOD server.

The control unit, when the event which stops an output of the broadcast program is completed, may control to output portions of the broadcast program which have not been broadcast continuously.

The control unit, when a predetermined time elapses after the event which stops an output of the broadcast program is completed, may control to output a message asking whether to output portions of the broadcast program which have not been broadcast continuously, and when a response to the output message is received through user interface, may control to output portions of the broadcast program which have not been broadcast continuously.

The control unit, when the event which stops an output of the broadcast program is completed and a predetermined user input is received, may control to output a message asking whether to output portions of the broadcast program which have not been broadcast continuously, and when a response to the output message is received through the user command receiving unit, may control to output portions of the broadcast program which have not been broadcast continuously.

The control unit, when the event which stops an output of the broadcast program is completed and a command to turn on a broadcast receiving apparatus is received, may control to output a message asking whether to output portions of the broadcast program which have not been broadcast continuously, and when a response to the output message is received through the user command receiving unit, may control to output portions of the broadcast program which have not been broadcast continuously.

The control unit, if there are a plurality of broadcast programs which have not been broadcast completely, when the event which stops an output of the broadcast program is completed, may control to output information regarding a list of the broadcast programs which have not been broadcast completely, and when one item is selected from a list of the broadcast programs which have not been broadcast completely through the user command receiving unit, may control to output a broadcast program corresponding to the selected item continuously.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 illustrates an Electronic Program Guide (EPG) which is executed to schedule a broadcast in the conventional art;

FIG. 2 is a block diagram illustrating a digital television according to an exemplary embodiment of the present invention;

FIG. 3 is a flow chart describing a method for scheduling a broadcast according to an exemplary embodiment of the present invention;

FIG. 4 illustrates a screen for scheduling a broadcast relating to a current broadcast according to an exemplary embodiment of the present invention;

FIG. 5 is a flow chart describing a method for scheduling a broadcast according to another exemplary embodiment of the present invention;

FIG. 6 is a block diagram illustrating a broadcast receiving apparatus according to yet another exemplary embodiment of the present invention;

FIGS. 7 and 8 are views illustrating a display screen for scheduling a broadcast according to another exemplary embodiment; and

FIGS. 9 and 10 are flowchart illustrating a method for scheduling a broadcast according to various exemplary embodiments.

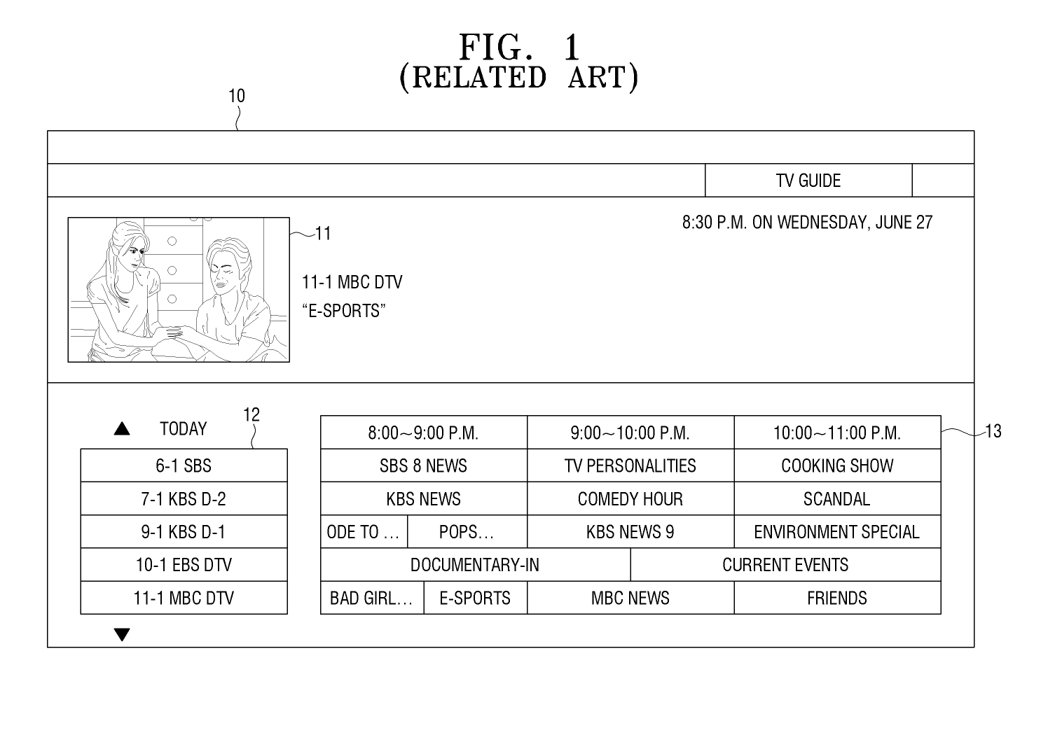

### DETAILED DESCRIPTION OF EXEMPLARY EMBODIMENTS OF THE INVENTION

Certain exemplary embodiments of the present invention will now be described in greater detail with reference to the accompanying drawings.

In the following description, same drawing reference numerals are used for the same elements even in different drawings. The matters defined in the description, such as detailed construction and elements, are provided to assist in a comprehensive understanding of the invention. Thus, it is apparent that the present invention can be carried out without those specifically defined matters. Also, well-known functions or constructions are not described in detail since they would obscure the invention with unnecessary detail.

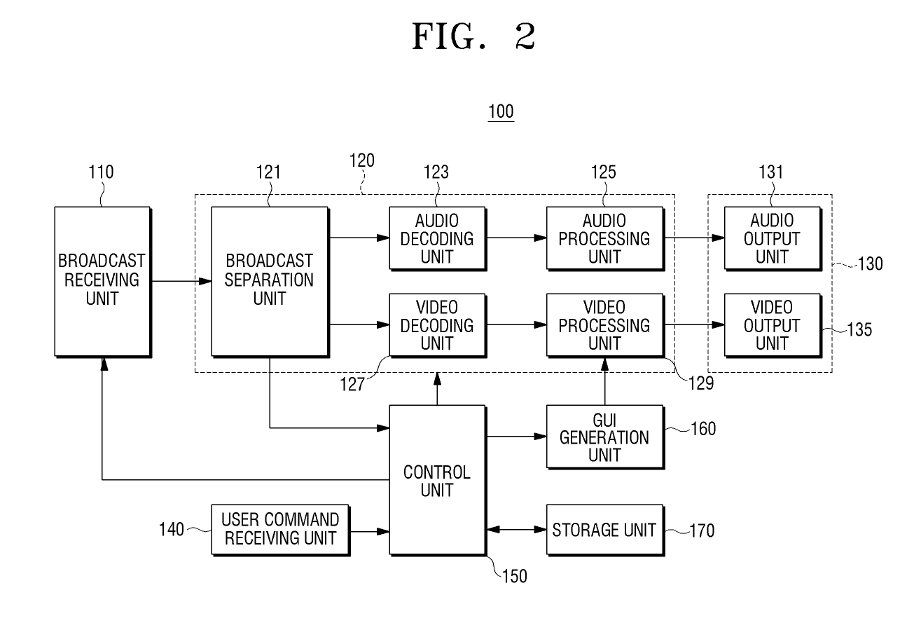

FIG. 2 is a block diagram illustrating a digital television (DTV) 100 according to an exemplary embodiment of the present invention. The DTV 100 provides users with digital broadcasts and a function for scheduling broadcasts relating to the currently viewed program.

As shown in FIG. 2, the DTV 100 includes a broadcast receiving unit 110, a broadcast processing unit 120, a broadcast output unit 130, a user command receiving unit 140, a control unit 150, a graphic user interface (GUI) generation unit 160, and a storage unit 170.

The broadcast receiving unit 110 tunes to, and demodulates one of broadcasts received wiredly or wirelessly.

The broadcast processing unit 120 processes broadcast signals output from the broadcast receiving unit 110. The broadcast processing unit 120 includes a broadcast separation unit 121, an audio decoding unit 123, an audio processing unit 125, a video decoding unit 127, and a video processing unit 129.

The broadcast separation unit 121 separates a video signal, an audio signal, and additional data from the broadcast signal.

The separated additional data is transmitted to the control unit 150 in order to be used to provide users with additional information.

The audio decoding unit 123 decodes the audio signal output from the broadcast separation unit 121, and so outputs the decompressed audio signal.

The audio processing unit 125 converted the decoded audio signal in a format to be output through a speaker mounted in the DTV 100.

The video decoding unit 127 decodes the video signal output from the broadcast separation unit 121, and so outputs decompressed video signal.

The video processing unit 129 converted the decoded video signal in a format to be output through a display mounted in the DTV 100. That is, the video processing unit 129 performs color processing and scaling of the video signal.

The GUI generation unit 160 generates a GUI to be shown on the display. The generated GUI is transmitted to the video processing unit 129, and added to video to be shown on the display. This process is called on-screen display (OSD).

The broadcast output unit 130 outputs video and audio corresponding to the video signal and audio signal output from the broadcast processing unit 120, and provides the output video and audio to the user. The broadcast output unit 130 includes an audio output unit 131 and a video output unit 135.

The audio output unit 131 outputs the audio signal output from the audio processing unit 125 through the speaker or an external display connected using an external output element, for example, an external television.

The video output unit 135 outputs the video signal output from the video processing unit 129 through the display or the external display connected using the external output element, for example, the external television.

The user command receiving unit 140 transmits a user command received from a remote control to the control unit 150, and the control unit 150 controls the entire operation of the DTV 100 according to the user command.

In more detail, the control unit 150 operates the broadcast receiving unit 110 and the broadcast processing unit 120 to provide users with digital broadcast programs.

The storage unit 180 is a medium to store broadcast programs, and may be a memory, a hard disk drive (HDD), or the like.

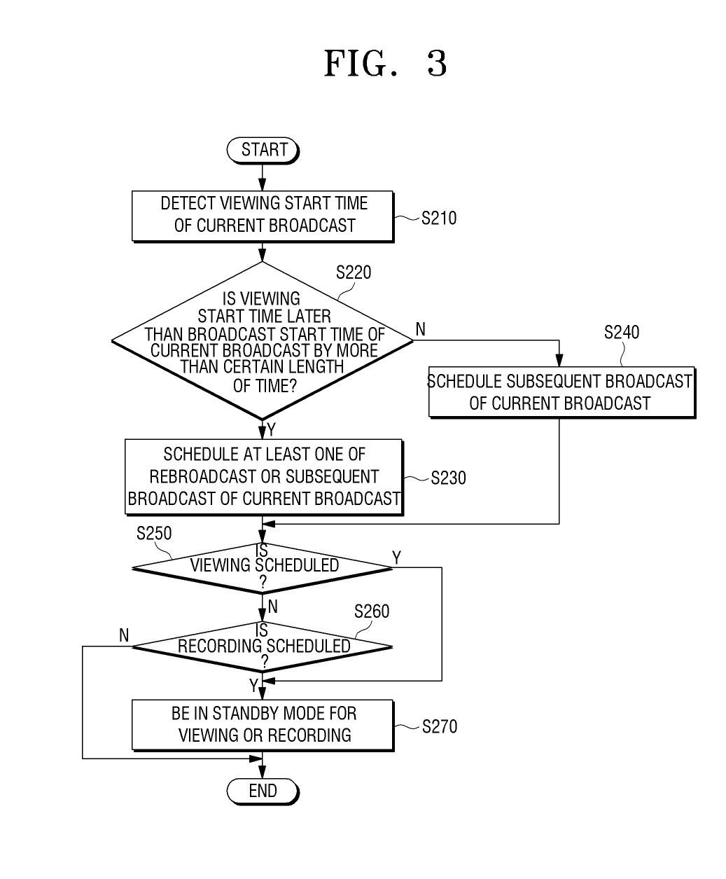

FIG. 3 is a flow chart describing a method for scheduling a broadcast according to an exemplary embodiment of the present invention.

In operation S210, the control unit 150 detects the viewing start time of a current broadcast.

In operation S220, the control unit 150 determines whether the viewing start time is later than a broadcast start time of the current broadcast by more than a certain length of time based on the detected viewing start time.

If the viewing start time is later than the broadcast start time of the current broadcast by more than the certain length of time in operation S220-Y, the user may view the rebroadcast of the current broadcast as he or she did not view the current broadcast from the beginning.

Accordingly, in operation S230, the control unit 150 provides the user with a UI to schedule the rebroadcast together with a UI to schedule a subsequent broadcast of the current broadcast. Specifically, the control unit 150 outputs a signal to provide the UI to the GUI generation unit 160, and the GUI generation unit 160 receives the signal, generates a GUI to be displayed on the display, outputs the GUI to the video processing unit 129.

In operation S220-N, if the viewing start time is earlier than the broadcast start time of the current broadcast, if the viewing start time is identical to the broadcast start time of the current broadcast, or if the viewing start time is later than the broadcast start time of the current broadcast by less than a certain length of time, the user may not wish to view the rebroadcast of the current broadcast as he or she may be able to view the current broadcast from the beginning.

Accordingly, in operation S240, the control unit 150 provides the user with a UI to schedule a subsequent broadcast of the current broadcast.

Consequently, the user can schedule the rebroadcast or subsequent broadcast of the current broadcast using the UI. However, the user may wish to view the rebroadcast or subsequent broadcast of the current broadcast in persion. Accordingly, in operation S250, the control unit 150 provides a UI to schedule viewing of the rebroadcast or subsequent broadcast of the current broadcast.

If the user schedules viewing of the rebroadcast or subsequent broadcast of the current broadcast in operation S250-Y, the control unit 150 operates the DTV 100 to be in a standby mode for viewing, as the user does not record the broadcast to be viewed in operation S270.

On the contrary, if the user does not schedule viewing of the rebroadcast or subsequent broadcast of the current broadcast in operation S250-N, the control unit 150 provides a UI to select whether the user schedules recording of the rebroadcast or subsequent broadcast of the current broadcast, since the user may wish to record the broadcast in operation S260.

If the user schedules recording of the rebroadcast or subsequent broadcast of the current broadcast in operation S260-Y, the control unit 150 operates the DTV 100 to be in the standby mode for recording in operation S270. As described above, scheduling broadcasts relating to the current broadcast can be set based on the viewing start time of the current broadcast.

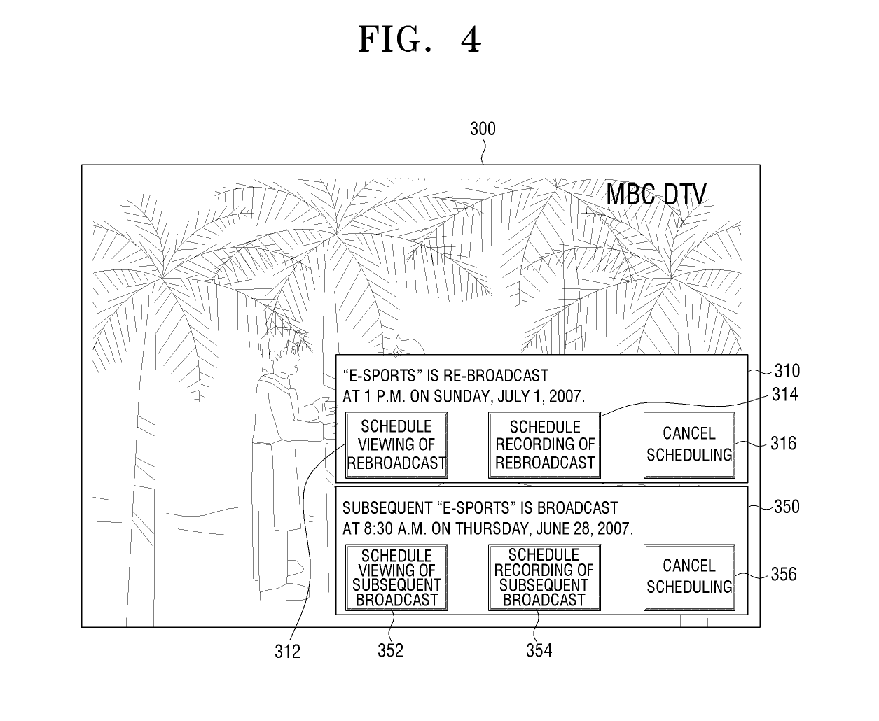

FIG. 4 illustrates a screen for scheduling a broadcast relating to a current broadcast according to an exemplary embodiment of the present invention.

A graphic 310 showing a schedule of the rebroadcast of the current broadcast and a graphic 350 showing a schedule of the subsequent broadcast of the current broadcast are displayed on the lower right of the screen of the current broadcast 300.

If the user has been viewing the current broadcast from the broadcast start time of the current broadcast, but will not view the current broadcast until the broadcast finish time of the current broadcast, the user must take an action such as recording the rebroadcast of the current broadcast. Accordingly, the graphics 310 and 350 may be automatically provided at the broadcast finish time of the current broadcast.

The graphic 310 showing a schedule of the rebroadcast of the current broadcast includes an icon 312 for scheduling viewing of the rebroadcast, an icon 314 for scheduling recording of the rebroadcast, and an icon 316 for canceling scheduling. The user can select whether to schedule viewing or recording of the rebroadcast by selecting one of the icons.

The graphic 350 showing a schedule of the subsequent broadcast of the current broadcast includes an icon 352 for scheduling viewing of the subsequent broadcast, an icon 354 for scheduling recording of the subsequent broadcast, and an icon 356 for canceling scheduling. The user can select whether to schedule viewing or recording of the subsequent broadcast by selecting one of the icons.

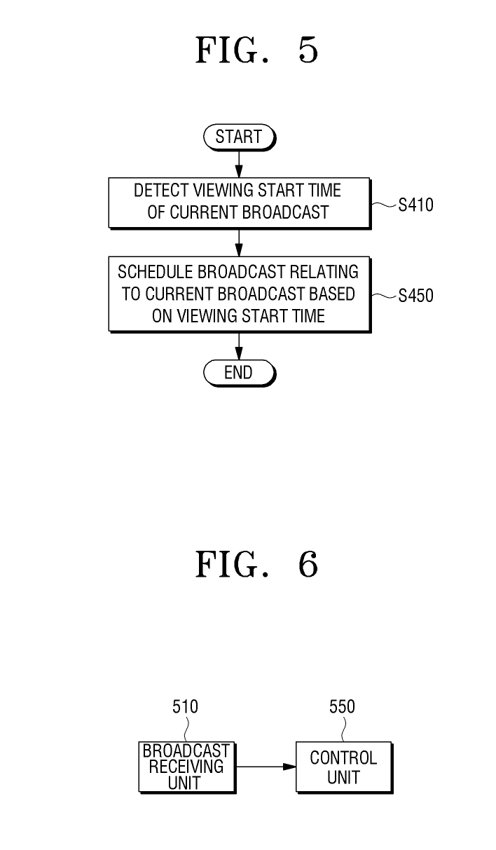

FIG. 5 is a flow chart describing a method for scheduling a broadcast according to another exemplary embodiment of the present invention.

A broadcast receiving apparatus detects a viewing start time of a current broadcast in operation S410, and then schedules of a broadcast relating to the current broadcast based on the viewing start time in operation S450.

FIG. 6 is a block diagram illustrating a broadcast receiving apparatus according to yet another exemplary embodiment of the present invention.

The broadcast receiving apparatus includes a broadcast receiving unit 510, and a control unit 550.

The broadcast receiving unit 510 receives and outputs a wired or wireless broadcast to the control unit 550, and the control unit 550 controls the entire operation of the DTV 100 using signals received from the broadcast receiving unit 510.

Therefore, scheduling broadcasts relating to a current broadcast can be set based on the viewing start time of the current broadcast.

In the above exemplary embodiments, the graphics 310 and 350 are described to be automatically provided at the finish time of the current broadcast, but this is just to facilitate understanding of the description. Accordingly, the user can also request to personally schedule using an input unit.

In this case, if the viewing start time is later than the broadcast start time of the current broadcast by more than a certain length of time, the graphics 310 and 350 for showing schedules on the rebroadcast and the subsequent broadcast of the current broadcast can be provided, and if the viewing start time is earlier than the broadcast start time of the current broadcast, if the viewing start time is identical to the broadcast start time of the current broadcast, or if the viewing start time is later than the broadcast start time of the current broadcast by less than a certain length of time, the graphic 350 showing a schedule of the subsequent broadcast of the current broadcast can be provided, as described in the exemplary embodiments above.

As can be appreciated from the above description, scheduling broadcasts relating to a current broadcast can be set based on the viewing start time of the current broadcast so that desired broadcasts can easily be scheduled, users' behavioral needs are met, and the chances of viewing the desired broadcasts increase.

Hereinafter, an exemplary embodiment where, when a user stops viewing a broadcast, the broadcast may be viewed later from a point of time when the broadcast stops, will be described.

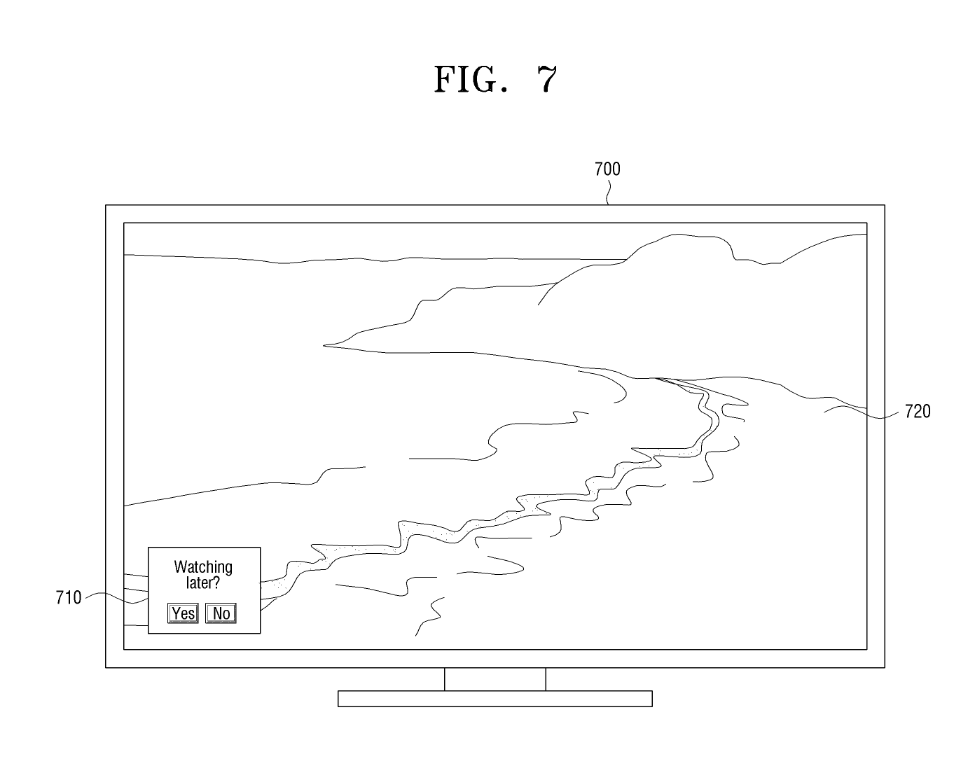

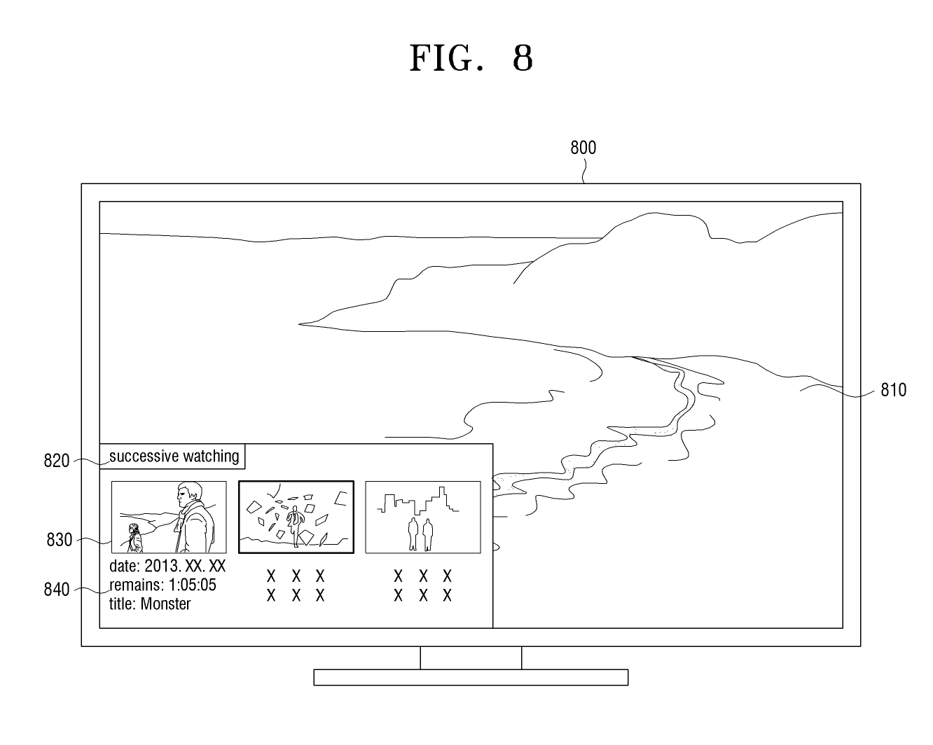

FIGS. 7 and 8 are views illustrating a display screen for scheduling a broadcast according to another exemplary embodiment.

While a user views a broadcast, an event may occur and thus, the viewing of the broadcast may be stopped. In this case, the types of the event do not matter. In other words, the event may include any case where it is impossible to display a broadcast which has been displayed, such as, but not limited to, a case where the reception or display of a broadcast may not be possible due to physical reasons, and a case where a user changes the channel of the DTV 100 or turns off the DTV 100. More specific description will be provided below.

For example, there may be a case where the reception of a broadcast is not possible due to errors in receiving a broadcast signal. On the other hand, a command to change channels may be received through a remote controller (or another interface of the DTV) and thus, a tuning channel may be changed, or a command to turn off the DTV 100 may be received, and thus the DTV 100 may be turned off.

In this case, the control unit 150 of the DTV 100 stores information regarding the broadcast which has been viewed in the storage unit 170. Herein, the information regarding the broadcast may be various information regarding the broadcast contents which have been displayed. For example, as illustrated in FIG. 8, the information may be at least one of a date, an entire running time, a viewing time, a remaining time, a title, identification information, channel information, and capacity (840 of FIG. 8). However, the information is not limited thereto.

On the other hand, the control unit 150 may control the broadcasting signal receiving unit to receive broadcast contents after the broadcast stops from another source such as a video on demand (VOD), perform recording, and store the same in the storage unit 170.

In this case, the control unit 150 may control the GUI generation unit 160 to generate a message 710 asking a user whether to view the broadcast which the user has been viewing continuously at a later time, and display the generated GUI as illustrated in FIG. 7. The user may transmit a response to the message to the DTV 100 through a remote controller, etc. When the user transmits a response indicating that he or she wishes to view the broadcast later, the control unit 150 may store information regarding the broadcast in the storage unit 170, or may receive broadcast contents after the broadcast stops from another source and store the same in the storage unit 170. On the other hand, when the user transmits a response indicating that he or she does not wish to view the broadcast, or does not transmit a response message within a predetermined period of time, the control unit 150 may not perform any manipulation regarding the stopped broadcast, therefore preventing the storage space from being unnecessarily wasted.

When the above-event is completed, the control unit 150 reads out stored the broadcast information and provides the broadcast information to the user, so that the user may watch the broadcast continuously.

In an exemplary embodiment, if the user turns on the DTV 100 again, the GUI generation unit 160 may provide the user with a user interface asking whether the user wishes to watch the stopped broadcast content continuously under the control of the control unit 150. If there are a plurality of broadcast contents, the broadcast contents may be provided in the form of a thumbnail 830 or a list as illustrated in FIG. 8, and the user may select and watch broadcast contents using a remote controller.

In another exemplary embodiment, when a predetermined time elapses, the GUI generation unit 160 of the DTV 100 may generate and display an alarm message. The alarm message provides a user interface asking whether the user wishes to watch the stopped broadcast content continuously. If there are a plurality of broadcast contents, the broadcast contents may be provided in the form of a thumbnail 830 or a list as illustrated in FIG. 8, and the user may select and watch broadcast contents using a remote controller.

In another exemplary embodiment, a control command to ask for content information of which the broadcast has been stopped as a specific button is pressed by the user or another manipulation means may be generated and transmitted to the DTV 100. The user command receiving unit 140 of the DTV 100 receives such a control command. The control unit 150 may display the broadcast content information of which the broadcast has been stopped according to the control command, and the broadcast content selected by the user's selection input may be displayed in the above-described way. Likewise, if there are a plurality of broadcast contents, the broadcast contents may be provided in the form of a thumbnail 830 or a list as illustrated in FIG. 8, and the user may select and watch the broadcast contents using a remote controller.

If information regarding the broadcast is stored, the control unit 150 controls to receive a streaming service from a source which provides the broadcast and displays the broadcast in real time. On the other hand, if the broadcast content is stored in the storage unit 170, the control unit 150 controls to read out and display the stored broadcast content.

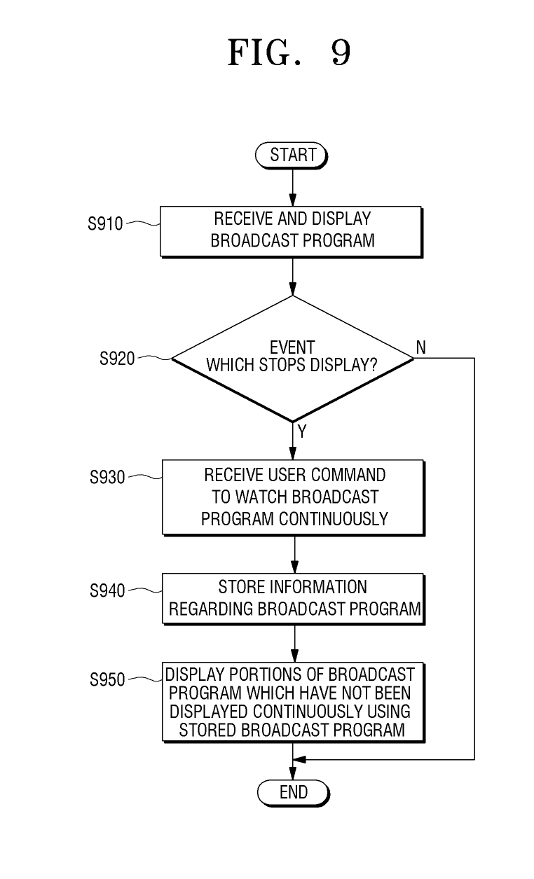

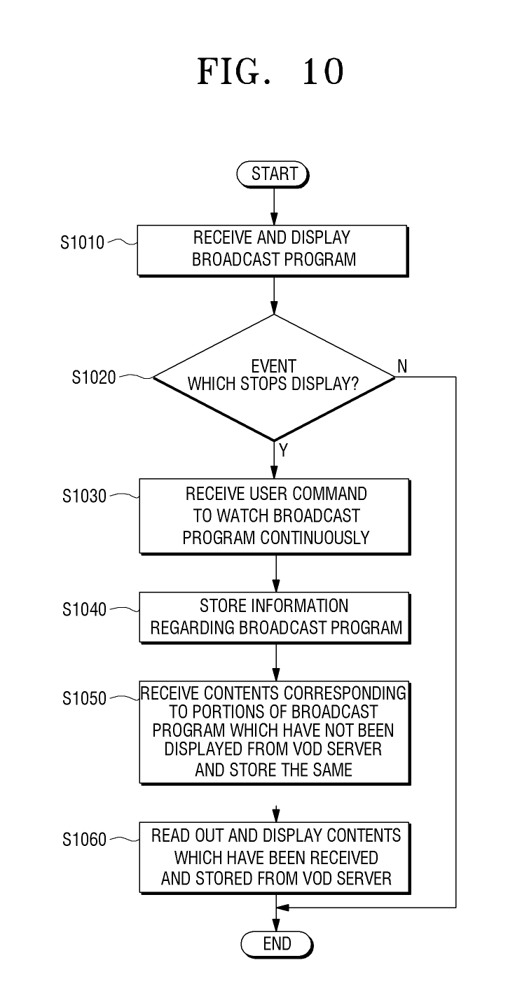

FIGS. 9 and 10 are flowcharts illustrating a method for scheduling a broadcast according to various exemplary embodiments.

Referring to FIG. 9, a broadcast scheduling method according to an exemplary embodiment comprises receiving and displaying a broadcast program (S910), and when an event which stops the displaying of the broadcast program occurs (S920-Y), receiving a user command to watch the broadcast program continuously (S930). When the broadcast program is received, information regarding the broadcast program is stored (S940). When the event that stops the displaying of the broadcast program is completed, the portions of the broadcast program which have not been broadcasted are displayed continuously using the stored information regarding the broadcast program (S950). Each of the operations is the same as described above.

Referring to FIG. 10, a broadcast scheduling method according to another exemplary embodiment comprises receiving and displaying a broadcast program (S1010), and when an event which stops the displaying of the broadcast program occurs (S1020-Y), receiving a user command to watch the broadcast program continuously (S1030). When the broadcast program is received, information regarding the broadcast program is stored (S1040). Subsequently, the contents corresponding to the portions of the broadcast program which have not been broadcast are received from a VOD server and stored using the information regarding the broadcast program (S1050). When the event that stops displaying the broadcast program is completed, the content which was received from the VOD server and stored is read out and displayed (S1060). Each of the operations is the same as described above.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

1: A method for scheduling a broadcast, the method comprising:
receiving and outputting a broadcast program;
when an event which stops an output of the broadcast program occurs while the broadcast program has not been completed, receiving a user command to watch the broadcast program continuously at a later time;
storing information regarding the broadcast program in response to receiving the user command; and
outputting portions of the broadcast program which have not been output continuously using the stored information regarding the broadcast program.

2: The method as claimed in claim 1, wherein the event is at least one of changing channels, turning off a broadcast receiving apparatus, and impossibility of receiving the broadcast by the broadcast receiving apparatus.

3: The method as claimed in claim 1, wherein the receiving the user command comprises:
outputting a message asking whether to watch the broadcast program continuously at a later time; and
receiving a response to the message through a user interface.

4: The method as claimed in claim 1, wherein the stored information regarding the broadcast program is at least one of an entire running time, a viewing time, a title, identification information, channel information and storage capacity.

5: The method as claimed in claim 1, further comprising:
when the user command is received, receiving a content corresponding to portions of the broadcast program which have not been broadcast from a video on demand (VOD) server and storing the content,
wherein the outputting the portions of the broadcast program which have not been output continuously comprises reading out and outputting the content received and stored from the VOD server.

6: The method as claimed in claim 1, wherein, when the event which stops an output of the broadcast program is completed, portions of the broadcast program which have not been broadcast are output continuously.

7: The method as claimed in claim 1, wherein the outputting the portions of the broadcast program which have not been output continuously comprises:
when a predetermined time elapses after the event which stops the output of the broadcast program is completed, outputting a message asking whether to output portions of the broadcast program which have not been broadcast continuously; and
when a response to the output message is received through a user interface, outputting portions of the broadcast program which have not been broadcast continuously.

8: The method as claimed in claim 1, wherein the outputting the portions of the broadcast program which have not been output continuously comprises:
when the event which stops the output of the broadcast program is completed and a predetermined user input is received, outputting a message asking whether to output portions of the broadcast program which have not been broadcast continuously; and
when a response to the output message is received through a user interface, outputting portions of the broadcast program which have not been broadcast continuously.

9: The method as claimed in claim 1, wherein the outputting the portions of the broadcast program which have not been output continuously comprises:
when the event which stops an output of the broadcast program is completed and a command to turn on a broadcast receiving apparatus is received, outputting a message asking whether to output portions of the broadcast program which have not been broadcast continuously; and
when a response to the output message is received through a user interface, outputting portions of the broadcast program which have not been broadcast continuously.

10: The method as claimed in claim 1, wherein the outputting the portions of the broadcast program which have not been output continuously comprises:
if there are a plurality of broadcast programs which have not been broadcast completely, when the event which stops an output of the broadcast program is completed, outputting a list of the broadcast programs which have not been broadcast completely; and
when one item is selected from the list of the broadcast programs which have not been broadcast completely through a user interface, outputting a broadcast program corresponding to the selected item continuously.

11: A broadcast receiving apparatus, comprising:
a broadcast signal receiving unit which is configured to receive a broadcast program;
a broadcast output unit which is configured to output the received broadcast program;
a user command receiving unit which is configured to receive a user command to watch the broadcast program at a later time when an event which stops the output of the broadcast program occurs while the broadcast program has not been completed;
a storage unit which is configured to store information regarding the received broadcast program when the user command is received; and
a control unit which is configured to control the broadcast output unit output portions of the broadcast program which have not been broadcast continuously based on the stored information regarding the broadcast program.

12: The apparatus as claimed in claim 11, wherein the event is at least one of changing channels, turning off a broadcast receiving apparatus, and impossibility of receiving the broadcast of the broadcast receiving apparatus.

13: The apparatus as claimed in claim 11, wherein the control unit is configured to control the broadcast output unit to output a message asking whether to watch the broadcast program continuously at a later time, and receive a response to the message through the user command receiving unit.

14: The apparatus as claimed in claim 11, wherein the stored information regarding the broadcast program is at least one of an entire running time, a viewing time, a title, identification information, channel information and storage capacity.

15: The apparatus as claimed in claim 11, wherein the control unit, when the user command is received, is configured to control the broadcast signal receiving unit to receive a content corresponding to portions of the broadcast program which have not been broadcast from a video on demand (VOD) server, store the content, and read out and output the received content.

16: The apparatus as claimed in claim 11, wherein the control unit, when the event which stops an output of the broadcast program is completed, is configured to control the broadcast output unit to output portions of the broadcast program which have not been broadcast.

17: The apparatus as claimed in claim 11, wherein the control unit, when a predetermined time elapses after the event which stops an output of the broadcast program is completed, is configured to control the broadcast output unit to output a message asking whether to output portions of the broadcast program which have not been broadcast, and when a response to the output message is received through a user interface, is configured to control the broadcast output unit to output the portions of the broadcast program which have not been broadcast continuously.

18: The apparatus as claimed in claim 11, wherein the control unit, when the event which stops an output of the broadcast program is completed and a predetermined user input is received, is configured to control the broadcast output unit to output a message asking whether to output portions of the broadcast program which have not been broadcast, and when a response to the output message is received through the user command receiving unit, is configured to control the broadcast output unit to output portions of the broadcast program which have not been broadcast continuously.

19: The apparatus as claimed in claim 11, wherein the control unit, when the event which stops an output of the broadcast program is completed and a command to turn on a broadcast receiving apparatus is received, is configured to control the broadcast output unit to output a message asking whether to output the portions of the broadcast program which have not been broadcast continuously, and when a response to the output message is received through the user command receiving unit, is configured to control the broadcast output unit to output portions of the broadcast program which have not been broadcast continuously.

20: The apparatus as claimed in claim 11, wherein the control unit, if there are a plurality of broadcast programs which have not been broadcast completely, when the event which stops an output of the broadcast program is completed, is configured to control the broadcast output unit to output a list of the broadcast programs which have not been broadcast completely, and when one item is selected from the list of the broadcast programs which have not been broadcast completely through the user command receiving unit, is configured to control the broadcast output unit to output a broadcast program corresponding to the selected item continuously.
